(19) United States
(12) Patent Application Publication
(10) Pub. No.: US 2011/0035150 A1
(43) Pub. Date: Feb. 10, 2011

(54) SIMPLE TECHNIQUE FOR DYNAMIC PATH PLANNING AND COLLISION AVOIDANCE

(75) Inventors: Suresh SUNDARRAJ, Bangalore (IN); Rajesh RAGHAVAN, Bangalore (IN); Bhargav Ramchandra BELLUR, Bangalore (IN)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/537,884

(22) Filed: Aug. 7, 2009

(51) Int. Cl. G08G 1/16; G01S 3/02

(52) U.S. Cl. 701/301; 342/455

(57) ABSTRACT

A system and method for dynamically mapping the position and speed of objects around a vehicle for collision avoidance purposes. The method determines the velocity of the vehicle in at least two orthogonal directions along with the position of the vehicle. From this information, a distance function map of the vehicle is created in a predefined area that includes a distance value at concentric locations from the vehicle. The distance function map is combined with distance function maps from all of the objects in the predefined area to determine whether a potential collision exists between the particular vehicle and any of the other objects.

### BACKGROUND OF THE INVENTION

1. Field of the Invention

This invention relates generally to a system and method for providing collision detection in a vehicle and, more particularly, to a system and method for providing collision detection in a vehicle that includes dynamically mapping the motion of objects around the vehicle in a defined area and determining whether the motion of the objects may cause a collision with the vehicle.

2. Discussion of the Related Art

Traffic accidents and roadway congestion are significant problems for vehicle travel. Current collision avoidance systems are typically based on radar/lidar technology where sensors on the vehicle detect moving objects around the vehicle and provide warning signals to the driver of a potential or impending collision, possibly even taking automatic evasive action.

Vehicular ad-hoc network based active safety and driver assistance systems allow a vehicle communications system to transmit messages to other vehicles in a particular area with warning messages about dangerous road conditions, driving events, accidents, etc. In these systems, multi-hop geocast routing protocols, known to those skilled in the art, are commonly used to extend the reachability of the warning messages, i.e., to deliver active messages to vehicles that may be a few kilometers away from the road condition, as a one-time multi-hop transmission process. In other words, an initial message advising drivers of a potential hazardous road condition is transferred from vehicle to vehicle using the geocast routing protocol so that vehicles at a significant distance away will receive the messages because one vehicle's transmission distance is typically relatively short.

Modern vehicles typically have GPS receivers that provide vehicle tracking and give the speed, direction and location of the vehicle. The above described vehicle communication systems can be combined with GPS location data to provide collision avoidance in vehicle systems in a simple manner. To enable such collision avoidance systems, vehicular ad hoc network based neighborhood awareness applications periodically transmit messages containing the kinematic state including position and velocity of the vehicle.

### SUMMARY OF THE INVENTION

In accordance with the teachings of the present invention, a system and method are disclosed for dynamically mapping the position and speed of objects around a vehicle for collision avoidance purposes. The method determines the velocity of the vehicle in at least two orthogonal directions along with the position of the vehicle. From this information, a distance function map of the vehicle is created in a predefined area that includes a distance value at concentric locations from the vehicle. The distance function map is combined with distance function maps from all of the objects, including static objects located in terrain maps of the geographic area in which the vehicle is currently present, in the predefined area to determine whether a potential collision exists between the particular vehicle and any of the other objects.

Additional features of the present invention will become apparent from the following description and appended claims, taken in conjunction with the accompanying drawings.

### BRIEF DESCRIPTION OF THE DRAWINGS

FIG. 1 is an illustration of a defined region including objects having a certain position and velocity;

FIG. 2 is a distance function map of a vehicle's position at a given instant in time;

FIG. 3 is a map showing a composite distance function or contours of the distance from multiple objects or vehicles in the defined region at an instant of time; and

FIG. 4 is a flow chart diagram showing a method for determining the relative position and velocity of objects using a level set algorithm.

### DETAILED DESCRIPTION OF THE EMBODIMENTS

The following discussion of the embodiments of the invention directed to a system and method for determining the relative position and velocity of objects in a predefined region for collision avoidance purposes is merely exemplary in nature, and is in no way intended to limit the invention or its applications or uses.

As will be discussed in detail below, the present invention employs a process for dynamically identifying the relative position of vehicles in a predefined region based on their position and velocities for collision avoidance purposes, where the information is transmitted between the vehicles in the region so that appropriate action can be taken in the event of a potential collision.

As will be described in detail below, the present invention employs a level set algorithm (LSA) to identify the potential for a collision that uses a level set equation, namely:

Φₜ+u·∇Φ=0

where Φ is a distance value from an object, Φₜ is the rate of change of Φ with respect to time and u is the velocity of the object.

A predefined region is defined around a particular vehicle where each vehicle in the region uses the level set algorithm. FIG. 1 is an exemplary example of such a region 10 showing vehicles V1, V2, V3 and V4, where each vehicle is generally represented by reference number 12, and where the vehicles V1, V2 and V3 are moving at some speed and the vehicle V4 is stationary. Each vehicle 12 is able to receive and download information, including GPS information of vehicle position, vehicle speed, vehicle direction, etc. at an instant in time from, for example, satellites, other vehicles, road-side structures, etc., using any suitable vehicle communications system. This information can also be obtained from built-in devices within the vehicle, such as a GPS monitoring device, through speedometers, or other vehicle to vehicle communication devices.

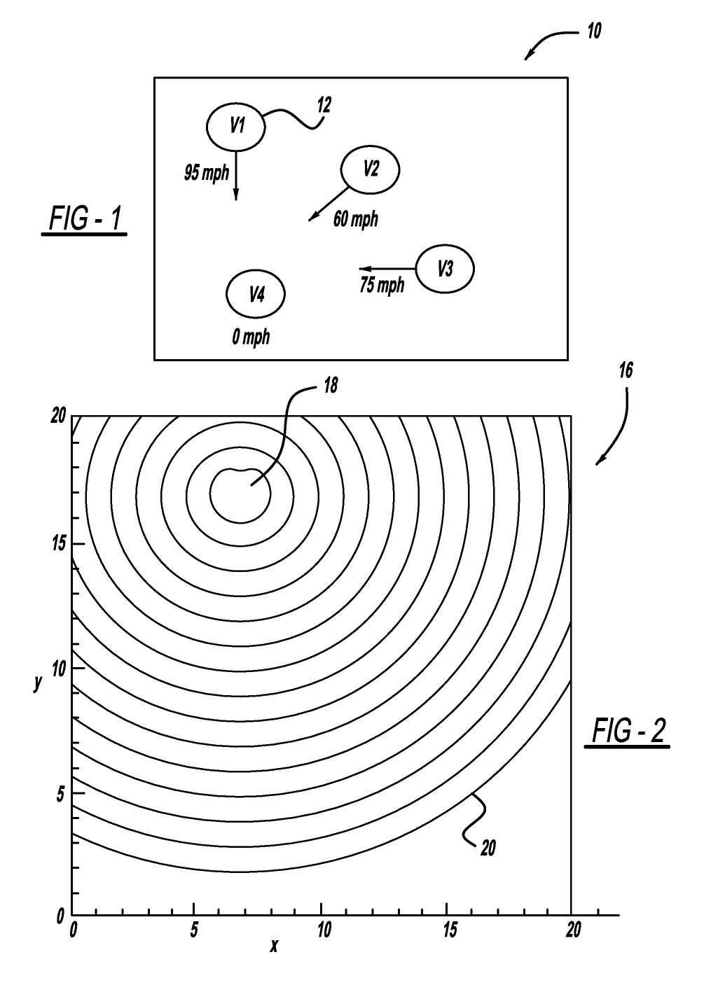

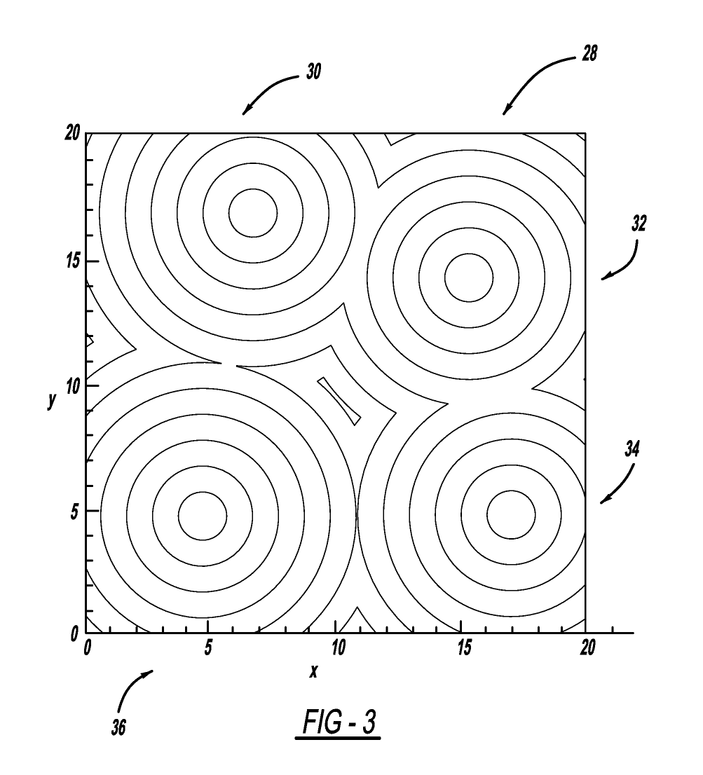

Using the LSA, each vehicle 12 generates an instantaneous distance function map based on a discrete finite volume grid in a given domain. FIG. 2 is a graph with velocity vector u being resolved in two directions, i.e., vehicle velocity components u in one direction on the horizontal axis and a vehicle velocity component v in an orthogonal direction on the vertical axis, showing an example of a distance function map 16 where the vehicle 12 would be at the center 18 of the map 12. Each concentric ring 20 identifies a distance value Φ. The level set equation determines the distance value Φ of each ring 20 from the center 18 along a vector normal to the ring 20. This example is one embodiment of how to apply the LSA to a flat terrain, such as region 10. In another embodiment of the invention, when considering terrains which are more 3-dimensional in nature (constituting say hills and valleys), the LSA can be applied to capture the three-dimensional terrain. However, in this case the velocity vector u would need to be resolved in 3 directions, u, v and w corresponding to the x, y and z coordinates of the region.

All of the distance function maps for all of the vehicles 12 in the defined region 10 are then combined into a composite map. Particularly, a composite distance function map is created using the LSA at each time iteration during the calculation with respect to the other vehicles 12 by minimization of the level set functions of all of the individual distance function maps. FIG. 3 shows such a composite distance function map 28 as a composite of a distance function map 30 for the vehicle V1, a distance function map 32 for the vehicle V2, a distance function map 34 for the vehicle V3 and a distance function map 36 for the vehicle V4.

At each sample time, the composite distance function map 28 will be updated as the vehicle 12 moves, and assuming that the vehicles 12 hold their current speed and direction, an estimate of the time for a potential collision between the vehicles 12 can be determined based on the dynamically changing distance contours provided by the composite distance function map 28 if such a potential for a collision exists. This information can then be used to provide warning signals or to take evasive action to prevent such a collision. For example, an optimization routine can be employed in conjunction with the LSA to suggest an optimal recovery path by analyzing the distance function contours of the neighboring vehicles 12.

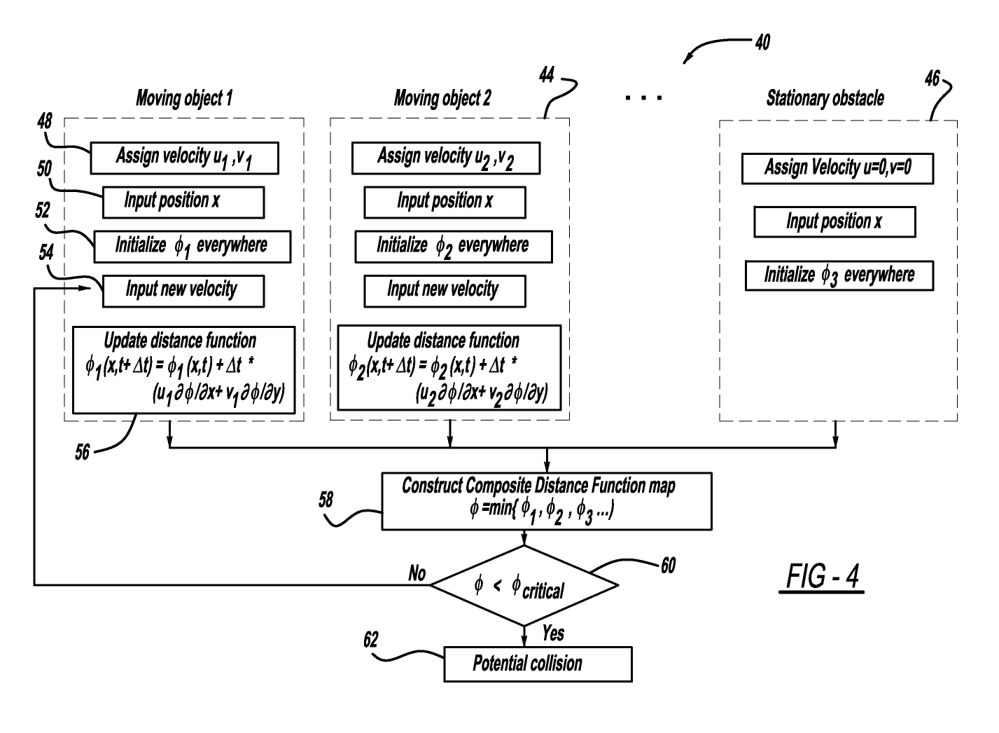

FIG. 4 is a flow chart diagram 40 showing the operation of the level set algorithm described above. Boxes 42 and 44 represent moving objects and box 46 represents a stationary object. Looking at the box 42 as representative, the level set algorithm assigns a velocity component to the object for both the u and v orthogonal directions at box 48. The algorithm then determines the position x of the object at box 50. The algorithm then initializes the distance function value Φ everywhere, i.e., at all of the rings 20, at box 52 using the following formula:

Φᵢₙᵢ=\sqrt{(x−xᵢₙᵢ)²+(y−yᵢₙᵢ)²}−rₒ

where xᵢₙᵢ and yᵢₙᵢ are the initial coordinates of the center of the object and rₒ is the radius defining the boundary of the object.

If the vehicle velocity has changed since the velocity has been assigned, then the new velocity is provided at box 54. The distance functions are then updated or calculated at box 56 to generate the distance function map, such as the one shown in FIG. 2, for that particular vehicle 12 using the equation:

Φ(x, t+Δt)=Φ(x,t)+Δt*(u₁∂Φ/∂x+v∂Φ/∂y)

As discussed above, each vehicle 12 determines its own distance function map using the level set algorithm. Once the distance function map for each vehicle 12 is provided at the box 56, then the algorithm constructs the composite distance function map 28 at box 58, such as shown in FIG. 3. In this embodiment, the vehicles 12 are transmitting their many distance function values Φ to each other and each vehicle 12 is calculating the various distance function maps for each vehicle 12 and then calculating the composite distance function map 28 based on all of the distance function values Φ it receives for the particular region 10. In an alternate embodiment, depending on the available bandwidth, each vehicle 12 may transmit its actual distance function map 16 to the other vehicles 12 where each vehicle 12 will then generate the composite distance function map 28 and may also transmit the calculated composite distance function map 28 to the other vehicles 12.

Once the composite distance function map 12 is determined, then the minimum distance function value Φ from all of the distance function values Φ for each of the vehicles 12 is selected at each vehicle 12 and it is compared to a threshold distance function value Φ_{critical} at decision diamond 60 to determine whether there is a potential for a collision for that particular vehicle 12 at box 62. If there is not a potential for a collision, then the algorithm returns to updating the distance function map by inputting a new velocity at the next sample time at the box 54. If the minimum distance function value Φ is less than the threshold distance function value Φ_{critical} at the decision diamond 60 and there is a potential collision at the box 62, then the system will proceed to take some action to avoid the collision. The collision avoidance can be provided by any suitable collision avoidance system that may be applicable for the particular vehicle in response to the potential collision with whatever object is determined to being in the path of the particular vehicle.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for determining the potential for a collision of a vehicle with an object in a defined area, said method comprising:
determining the velocity of the vehicle in at least two orthogonal directions;
determining the position of the vehicle;
determining a distance function including distance values of the vehicle at a plurality of concentric locations away from the vehicle and creating a distance function map from the plurality of distance functions in the defined area; and
combining the distance function map of the vehicle with a distance function map from other vehicles or other static object obtained from a terrain database corresponding to the geographic area in which the vehicle is present in the defined area to create a composite distance function map to determine the relative positions and velocities of the vehicles to determine the potential for a collision.

2. The method according to claim 1 wherein determining a distance function includes using the equation:
Φₜ+u·∇Φ=0
where Φ is the distance value and u is the velocity vector of the vehicle.

3. The method according to claim 1 wherein determining the velocity and position of the vehicle includes determining the velocity and position of the vehicle using GPS information.

4. The method according to claim 1 wherein the vehicle transmits the distance functions and a receiving vehicle creates the distance function map from the distance functions.

5. The method according to claim 1 wherein the vehicle transmits the created distance function map and a receiving vehicle receives the created distance function map.

6. The method according to claim 1 further determining whether a distance function value is less than a predetermined distance function threshold value, and if so, determining that a potential collision is probable.

7. The method according to claim 1 wherein determining the velocity of the vehicle in at least two orthogonal directions includes updating the velocity at regular intervals.

8. A method for determining the potential for a collision of a vehicle with an object, said method comprising:
defining a region including vehicles within a defined region;
determining the velocity of the vehicle in two orthogonal directions at regular intervals;
determining the position of the vehicle;
determining a distance function including a distance value of the vehicle at a plurality of concentric locations away from the vehicle and creating a distance function map from the plurality of distance functions in the defined region;
combining the distance function map of the vehicle with a distance function map from other vehicles in the defined region along with other static objects obtained from a terrain database corresponding to the geographic area in which the vehicle is present to create a composite distance function map; and
transmitting information including the distance functions between the vehicles in the defined region to determine the relative positions and velocities of the vehicles to determine the potential for a collision.

9. The method according to claim 8 wherein determining a distance function includes using the equation:
Φₜ+u·∇Φ=0
where Φ is the distance value and u is the velocity of the vehicle.

10. The method according to claim 8 wherein determining the velocity and position of the vehicle includes determining the velocity and position of the vehicle using GPS information.

11. The method according to claim 8 wherein transmitting information includes transmitting a kinematic state along with position and velocity of the vehicle where a receiving vehicle constructs a distance function map corresponding to the sending vehicle based on the information received.

12. The method according to claim 8 wherein transmitting information including the distance functions between the vehicles includes transmitting the distance functions where a receiving vehicle creates the distance function map from the distance functions.

13. The method according to claim 8 wherein transmitting information including the distance functions between the vehicles includes transmitting the created distance function map where a receiving vehicle receives the created distance function map.

14. The method according to claim 8 further comprising determining whether a distance function value is less than a predetermined distance function threshold value, and if so, determining that a potential collision is probable.

15. A system for determining the potential for a collision of a vehicle with an object in a defined area, said system comprising:
means for determining the velocity of the vehicle in at least two orthogonal directions;
means for determining the position of the vehicle;
means for determining a distance function including distance values of the vehicle at a plurality of concentric locations away from the vehicle and creating a distance function map from the plurality of distance functions in the defined area; and
means for combining the distance function map of the vehicle with a distance function map from other vehicles in the defined area to create a composite distance function map to calculate the relative positions and velocities of the vehicles to determine the potential for a collision.

16. The system according to claim 15 wherein the means for determining a distance function uses the equation:
Φₜ+u·∇Φ=0
where Φ is the distance value and u is the velocity of the vehicle.

17. The system according to claim 15 wherein the means for determining the velocity and position of the vehicle uses GPS information.

18. The system according to claim 15 wherein the vehicle transmits the distance functions and a receiving vehicle creates the distance function map from the distance functions.

19. The system according to claim 15 wherein the vehicle transmits the created distance function map and a receiving vehicle receives the created distance function map.

20. The system according to claim 15 further comprising means for determining whether a distance function value is less than a predetermined distance function threshold value, and if so, determining that a potential collision is probable.
